(19) United States
(12) Patent Application Publication
(10) Pub. No.: US 2026/0129546 A1
(43) Pub. Date: May 7, 2026

(54) METHOD AND DEVICES FOR MANAGING USER EQUIPMENT REGISTRATION DURING DISASTER ROAMING CONDITIONS

(71) Applicant: Samsung Electronics Co., Ltd., Suwon-si (KR)

(72) Inventors: Danish Ehsan HASHMI, Bangalore (IN); Lalith KUMAR, Bangalore (IN); Arvind RAMAMURTHY, Bangalore (IN); Jagadeesh GANDIKOTA, Bangalore (IN); Pratibha Kattemane SATYAGANAPATI, Bangalore (IN); Anurag MANDILWAR, Bangalore (IN)

(21) Appl. No.: 19/431,283

(22) Filed: Dec. 23, 2025

Related U.S. Application Data
(63) Continuation of application No. PCT/KR2025/017715, filed on Oct. 31, 2025.

(30) Foreign Application Priority Data
Nov. 6, 2024 (IN) 202441085220
Nov. 7, 2024 (IN) 202411085372
Oct. 8, 2025 (IN) 2024 41085220

(51) Int. Cl. H04W 36/36; H04W 60/04; H04W 60/06; H04W 76/30; H04W 84/06

(52) U.S. Cl. CPC H04W 36/362; H04W 60/04; H04W 60/06; H04W 76/30; H04W 84/06

(57) ABSTRACT

A method and systems for managing registration of user equipment (UE) during disaster roaming conditions are provided. The method includes receiving, by a network node of a secondary public land mobile network (PLMN), an indication about a termination of a disaster condition, from a primary PLMN, wherein the secondary PLMN provides disaster roaming services to the UE in an evolved packet system (EPS) during the disaster condition in fifth generation system, and transmitting, by the network node to the UE, a non-access stratum (NAS) message that includes radio access technology (RAT) utilization control information and a predefined reject cause prompting the UE to re-attach to the primary PLMN over the 5GS, upon receipt of the indication.

### CROSS-REFERENCE TO RELATED APPLICATION(S)

This application is a continuation application, claiming priority under 35 U.S.C. § 365 (c), of an International application No. PCT/KR2025/017715, filed on Oct. 31, 2025, which is based on and claims the benefit of an Indian Provisional patent application number 202441085220, filed on Nov. 6, 2024, in the Indian Intellectual Property Office, of an Indian Provisional patent application number 202411085372, filed on Nov. 7, 2024, in the Indian Intellectual Property Office, and of an Indian Complete patent application No. 202441085220, filed on Oct. 8, 2025, in the Indian Intellectual Property Office, the disclosure of each of which is incorporated by reference herein in its entirety.

### TECHNICAL FIELD

The disclosure relates to a technical field of wireless communication networks. More particularly, the disclosure relates to managing Radio Access Technology (RAT) restrictions and user equipment registration during disaster conditions.

### BACKGROUND

3rd generation partnership project (3GPP) is a collaborative project aimed at developing globally acceptable specifications for third generation (3G) mobile systems. The need to support different kinds of user equipment (UE), services, and technologies is driving the technological revolution to a high-performance and highly efficient 3GPP system. The 3GPP drivers include Internet of Things (IoT), Virtual Reality (VR), industrial control, ubiquitous on-demand coverage, as well as the opportunity to meet customized market needs. These drivers require enhancements to the devices, services, and technologies well established by 3GPP.

Third Generation Partnership Project (3GPP) standards are integral for ensuring that user equipment (UE) can effectively access Public Land Mobile Networks (PLMNs). The current technological landscape facilitates various functionalities for UEs, particularly under adverse conditions such as disasters, enabling them to switch between different network types to maintain connectivity. The provisions outlined in documents such as 3GPP TS 22.261 highlight the ability of UEs to access forbidden PLMNs in emergency scenarios when other networks are unavailable.

Subject to regulatory requirements, operator's policy or UE capabilities, 3GPP system shall be able to support a UE, with fifth generation (5G)-only national roaming access to a visited public land mobile network (VPLMN), to obtain fourth generation (4G) connectivity service (for example, voice call, mobile data service, and so on) from that VPLMN in the area where a disaster condition applies. This key issue will address the network selection for the 5G-only national roaming UE in the scenario either where there is no available PLMN except for the 4G PLMN in the “Forbidden PLMN lists” data field in the subscriber identification module (SIM)/universal subscriber identification module (USIM), and the available 5G VPLMN indicates that disaster condition applies, or where there is available 4G VPLMN which is not in the “Forbidden PLMN lists” data field in the SIM/USIM.

When a disaster condition is no longer applicable, all the UEs (which are currently being served by the VPLMN providing disaster roaming services in Evolved Packet System (EPS) and are currently in EMM-IDLE mode) may perform PLMN reselection and return to the VPLMN providing 5G-only national roaming access that was previously with disaster condition.

When a disaster condition is no longer applicable, the UEs (that are currently in EMM-CONNECTED mode) need to perform EPS to 5G interworking procedures in a way that does not lead to signalling overload in the VPLMN providing 5G-only national roaming access. In the above key issue description and in existing arts, there is no description of how a UE that is currently in EPS (to obtain disaster roaming service) will know that a disaster condition is no longer applicable.

Current methods lack clear protocols for signalling the resolution of disaster conditions, leaving UEs without definitive guidance on when they can return to their preferred networks such as, 5G, after being registered on alternate networks for disaster roaming services. Currently, there is no mechanism in existing arts where after an end of the disaster condition, a network can push 5G only roaming UEs that were registered on 5G, but moved to 4G due to disaster condition in 5G, back to 5G. This results in inefficiencies such as service interruptions, difficulties in network reselection, and potential signalling overload, leading to diminished user experience and inefficient network management during critical situations.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for managing Radio Access Technology (RAT) restrictions and user equipment registration during disaster conditions.

Additional aspects will be set forth in part in the description which follows and, in part, will be apparent from the description, or may be learned by practice of the presented embodiments.

In accordance with an aspect of the disclosure, a method of managing the registration of a user equipment (UE) during disaster roaming conditions is provided. The method includes receiving, by a network node associated with a secondary public land mobile network (PLMN), an indication about a termination of a disaster condition, from a primary PLMN, wherein the secondary PLMN provides disaster roaming services to the UE in an evolved packet system (EPS) during the disaster condition in fifth generation system (5GS), and transmitting, by the network node to the UE, a non-access stratum (NAS) message including radio access technology (RAT) utilization control information and a predefined reject cause indicating the UE to re-attach to the primary PLMN over the 5GS, upon receipt of the indication.

In accordance with another aspect of the disclosure, a network node for managing the registration of a user equipment (UE) during disaster roaming conditions, the network node being associated with a secondary public land mobile network (PLMN), is provided. The network node includes memory and at least one processor communicatively coupled to the memory, wherein the at least one processor is configured to receive an indication about a termination of a disaster condition, from a primary PLMN, wherein the secondary PLMN provides disaster roaming services to the UE in an evolved packet system (EPS) during the disaster condition in 5GS, and transmit a non-access stratum storage (NAS) message including radio access technology (RAT) utilization control information and a predefined reject cause indicating the UE to re-attach to the primary PLMN over a fifth generation system (5GS), upon receipt of the indication.

In accordance with another aspect of the disclosure, a method of restoring service to a user equipment (UE) during a disaster condition is provided. The method includes receiving, by the UE, from a network node associated with a secondary public land mobile network (PLMN), a non-access stratum (NAS) message comprising radio access technology (RAT) utilization control information and a predefined reject cause indicating to re-attach to a primary PLMN, wherein the NAS message indicates a termination of a disaster condition, and transmitting, by the UE, a re-registration request to the primary PLMN, upon receipt of the NAS message.

In accordance with another aspect of the disclosure, a user equipment (UE) for restoring service during a disaster condition is provided. The UE includes memory and at least one processor communicatively coupled to the memory, wherein the at least one processor is configured to receive from a network node associated with a secondary public land mobile network (PLMN), a non-access stratum (NAS) message comprising radio access technology (RAT) utilization control information and a predefined reject cause indicating to re-attach to a primary PLMN, wherein the NAS message indicates a termination of a disaster condition, and transmit a re-registration request to the primary PLMN, upon receipt of the NAS message.

Other aspects, advantages, and salient features of the disclosure will become apparent to those skilled in the art from the following detailed description, which, taken in conjunction with the annexed drawings discloses various embodiments of the disclosure.

### BRIEF DESCRIPTION OF THE ACCOMPANYING DRAWINGS

The above and other aspects, features, and advantages of certain embodiments of the disclosure will be more apparent from the following description taken in conjunction with the accompanying drawings, in which:

FIG. 1A is a representation of the problem scenario for returning of User Equipment (UE) to the visited public land mobile network (VPLMN), according to an embodiment of the disclosure;

FIG. 1B illustrates an environment for managing user equipment roaming in disaster conditions according to an embodiment of the disclosure;

FIG. 1C illustrates a block diagram of a network node for managing registration of User Equipment during disaster roaming conditions according to an embodiment of the disclosure;

FIG. 2 illustrates a detailed block diagram of a network node according to an embodiment of the disclosure;

FIG. 3 illustrates a detailed block diagram of a user equipment system according to an embodiment of the disclosure;

FIG. 4 illustrates a sequence diagram for managing user equipment registration during disaster roaming conditions according to an embodiment of the disclosure;

FIG. 5 is a representation of a RAT utilization control information element, according to an embodiment of the disclosure;

FIG. 6A illustrates a flowchart for managing registration of User Equipment (UE) during disaster roaming conditions according to an embodiment of the disclosure; and

FIG. 6B illustrates a flowchart for managing registration of User Equipment during the transition from a disaster roaming condition to normal operations, according to an embodiment of the disclosure.

Throughout the drawings, it should be noted that like reference numbers are used to depict the same or similar elements, features, and structures.

### Overview

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

3^{rd} generation partnership project (3GPP) is a collaborative project aimed at developing globally acceptable specifications for third generation (3G) mobile systems. The need to support different kinds of user equipment (UE), services, and technologies is driving the technological revolution to a high-performance and highly efficient 3GPP system. The 3GPP drivers include Internet of Things (IoT), Virtual Reality (VR), industrial control, ubiquitous on-demand coverage, as well as the opportunity to meet customized market needs. These drivers require enhancements to the devices, services, and technologies well established by 3GPP.

Currently, service requirements in 3GPP TS 22.261, provide means for the 3GPP system to provide means to enable a UE to access public land mobile networks (PLMNs) in a forbidden PLMN list if a disaster condition applies. Further, the 3GPP system also enables the UE to access the forbidden PLMN if no other PLMN is available except for PLMNs in the forbidden PLMN list.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

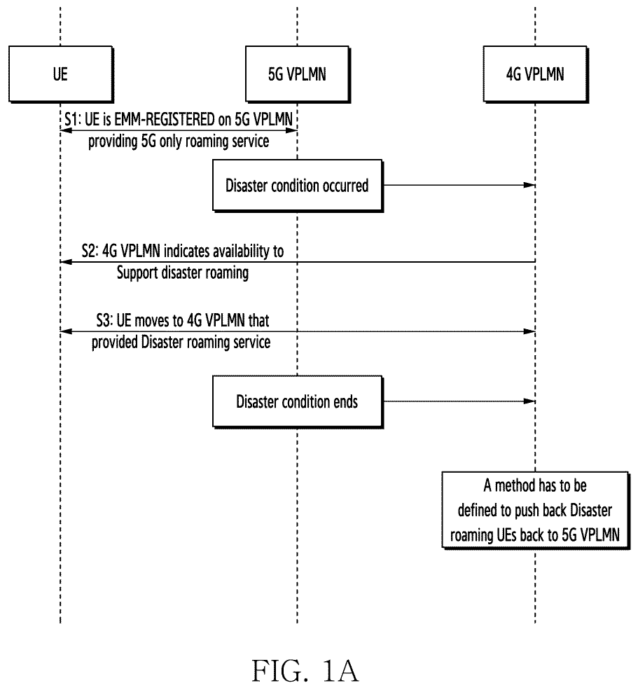

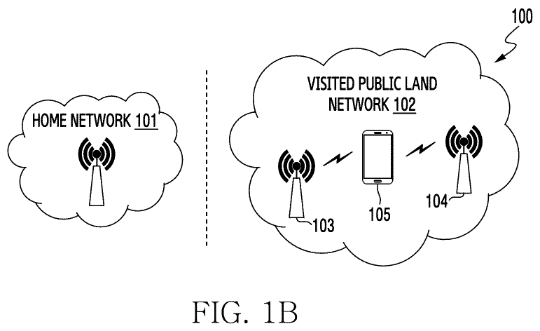

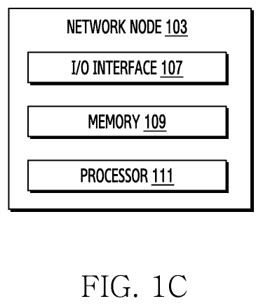

FIG. 1A is a representation of the problem scenario for returning User Equipment (UE) to the visited public land mobile network (VPLMN), in accordance with an embodiment of the disclosure.

In the depicted scenario in FIG. 1A, at operation S1, the 3GPP system may be able to support a UE with 5G-only national roaming access to a visited public land mobile network (VPLMN). In the case when a disaster condition occurs, the UE may need. to obtain 4G connectivity service (e.g. voice call, mobile data service) from that VPLMN in the area where the disaster condition applies, as shown in step S2 of FIG. 1A. The 3GPP support to the UE is subject to regulatory requirements, operator's policy, or UE capabilities.

In this scenario, the key issue of network selection arises where there is no available PLMN except for the 4G PLMN in the “Forbidden PLMN lists” data field in the Subscriber Identity Module/Universal Subscriber Identity Module (SIM/USIM), and the available 5G VPLMN indicates that disaster condition applies. In another scenario, the key issue of network selection arises where there is available 4G VPLMN which is not in the “Forbidden PLMN lists” data field in the SIM/USIM.

When a disaster condition is no longer applicable, all UEs which are currently served by the VPLMN providing disaster roaming services in Evolved Packet Service (EPS) and that are currently in EMM-IDLE mode, may perform PLMN reselection and return to the VPLMN providing 5G-only national roaming access that was previously with disaster condition as shown in step S3 of FIG. 1A.

When a disaster condition is no longer applicable, UEs that are currently in EMM-CONNECTED mode, EPS to 5G interworking procedures need to be performed in a way that does not lead to signaling overload in the VPLMN providing 5G-only national roaming access.

This leaves behind a technical problem of how to stagger the return of UEs to the VPLMN providing 5G-only national roaming access. As a baseline the mechanism already established for Rel-17 Minimization of Service Interruption (MINT) mechanism including the specified timer for MINT, e.g., the disaster return wait range, should be reused as much as possible.

As such, there is a need for a system and method to handle how a UE which is in EPS and is obtain disaster roaming service, can be pushed back to the 5G VPLMN providing 5G-only national roaming access.

As per key issues following service requirements in 3GPP TS 22.261, the 3GPP system shall be able to provide means to enable a UE to access PLMNs in a forbidden PLMN list if a Disaster condition applies and no other PLMN is available except for PLMNs in the forbidden PLMN list.

Subject to regulatory requirements, operator's policy or UE capabilities, the 3GPP system shall be able to support a UE, with 5G-only national roaming access to a VPLMN, to obtain 4G connectivity service (for example, voice call, mobile data service, and so on) from that VPLMN in the area where a Disaster Condition applies.

This key issue will address the network selection for the 5G-only national roaming UE in the scenario either where there is no available PLMN except for the 4G PLMN in the “Forbidden PLMN lists” data field in the SIM/USIM, and the available 5G VPLMN indicates that Disaster Condition applies, or where there is available 4G VPLMN which is not in the “Forbidden PLMN lists” data field in the SIM/USIM.

When a Disaster Condition is no longer applicable, all the UEs (which are currently being served by the VPLMN providing disaster roaming services in EPS and are currently in EMM-IDLE mode) will perform PLMN reselection and return to the VPLMN providing 5G-only national roaming access that was previously with Disaster Condition.

In another example, when a Disaster Condition is no longer applicable, the UEs (that are currently in EMM-CONNECTED mode) need to perform EPS to 5G interworking procedures in a way that does not lead to signalling overload in the VPLMN providing 5G-only national roaming access.

In the above key issue description and in existing arts, there is no description of how a UE that is currently in EPS (to obtain disaster roaming service) will know that a disaster condition is no longer applicable.

An embodiment herein is to disclose methods and systems for providing Radio Access Technologies (RAT) restrictions for Enhancement of controlling RAT utilization (ECRATU) in wireless communication technologies.

An embodiment herein discloses methods and systems for enabling a UE that is currently in EPS (to obtain disaster roaming service) to know that a disaster condition is no longer applicable.

The embodiments herein achieve methods and systems for providing Radio Access Technologies (RAT) restrictions for Enhancement of controlling RAT utilization (ECRATU) in wireless communication technologies.

The following definitions and abbreviations have been referred to herein:
RAT: Radio access technology defined in 3GPP TS 36.304 and 3GPP TS 38.304, respectively.
UE: User equipment
PLMN: Public land mobile network
TAI: Tracking area ID
EPS: Evolved Packet Service (LTE)
IE: Information Element
AMF: Access and Mobility Management Function
ePDG: Evolved Packet Data Gateway
MINT: Minimization of Service Interruption
PDN: Packet Data Network

Embodiments herein use the terms ‘Rat-Type’ and ‘RAT’ interchangeably and have the same meaning and they represent at least one of the following: 5G, 4G, third generation (3G), second generation (2G), EPS, 5GS, new radio (NR), NR in unlicensed bands, NR low earth orbit (LEO) satellite access, NR medium earth orbit (MEO) satellite access, NR geostationary earth orbit (GEO) satellite access, NR (OTHERSAT) satellite access, NR reduced capability (RedCap), evolved universal terrestrial radio access (E-UTRA), E-UTRA in unlicensed bands, narrowband internet of things (NB-IoT) or NB-S1, wireless broadband internet of things (WB-IoT), long-term evolution for machines (LTE-M), and so on.

Once the disaster condition is no longer applicable, the 5G VPLMN will indicate the same to the 4G VPLMN by means that are outside of 3GPP. In order to indicate that the 5G VPLMN is no longer under disaster conditions or that the 4G VPLMN does not provide Disaster roaming services anymore, the 4G VPLMN can use an existing or a new downlink NAS message.

The PLMN providing disaster roaming service may use one of the following NAS messages to indicate that the disaster condition no longer applies to the UE or that Disaster roaming is no longer supported or disaster condition has ended or that the UE has to go back to 5GS:
Global Unique Temporary Identifier (GUTI) reallocation command;
Authentication request/reject and Security mode command/Security mode reject
Identity request;
EMM information, wherein the EMM status can be Attach Accept/Reject,
TAU Accept/Reject, Service accept/reject,
DL NAS transport (DOWNLINK NAS TRANSPORT),
Detach request; and
DOWNLINK GENERIC NAS TRANSPORT.

Alternatively, the network may also use a new NAS message to indicate that the disaster condition is no longer applicable.

The network may use an existing information element (IE) or a new IE in the downlink NAS message to signal that the disaster condition is no longer applicable or that the PLMN no longer provides Disaster roaming services to the UE. The message may include an indication that such information is also provided as part of the message.

On receiving an indication that the 5G VPLMN is available and is no longer under disaster condition or that the 4G VPLMN no longer offers disaster roaming services. Optionally, the PLMN(s) (i.e. PLMN-IDs) for which disaster condition has ended are indicated to the UE, the UE shall reselect the 5G VPLMN that was providing service before the disaster condition occurred; i.e., the UE should trigger the PLMN selection procedure or cell selection or cell reselection procedure. Optionally, if the UE is in the registered state it will continue to remain in the registered state (i.e., EMM REGISTERED state).

For enabling a UE that is currently in EPS (to obtain disaster roaming service) to know that a disaster condition is no longer applicable is disclosed. First, the UE is registered on a 5G VPLMN providing 5G only service in roaming. Consider that a disaster condition occurs at 5G VPLMN. The UE detects the availability of 4G VPLMN which can provide disaster roaming services. The UE registers on 4G VPLMN for disaster roaming. Consider that the Disaster condition ends. In an embodiment, the 4G VPLMN indicates the UE with a new/existing Downlink NAS message that the Disaster roaming service is no longer supported. On receiving information that the 5G VPLMN is no longer affected by the disaster condition or that the 4G VPLMN no longer supports disaster roaming, the UE shall reselect the 5G VPLMN that was providing service to the UE before the disaster condition occurred.

Alternatively, the network can trigger a procedure (for example, GUTI reallocation procedure (with TAI list not including the current camped TAI)) to force the UE to initiate a registration procedure (for example, tracking area update procedure), then the network can indicate in the TAU accept or TAU reject message that the Disaster condition has ended as described herein. In summary, the network can trigger procedure-1 to force the UE to trigger procedure-2 and as part of procedure-2, the network will indicate to the UE that the disaster condition has ended. The procedure-1 and procedure-2 are the NAS procedures and can include the list of all NAS procedures as described in TS 24.301/TS 24.501.

The network can indicate that the disaster condition has ended for 5G VPLMN as part of the NAS message (for example, TAU reject or service reject message using a cause code (for example, #11, #12, #13, #14, #15, #31 or #15) with extended EMM cause to disable the EPS or LTE or S1 mode (E-UTRA capability)) optionally for this PLMN.

In an embodiment, when the network indicates that the disaster condition has ended, the UE can perform at least one of the below actions:

The UE shall set the EPS update status to EU3 ROAMING NOT ALLOWED (and shall store it according to clause 5.1.3.3) and shall delete any GUTI, last visited registered TAI, TAI list and eKSI. Additionally, the UE shall delete the list of equivalent PLMNs and reset the attach attempt counter. In S1 mode, the UE shall store the PLMN identity in the “forbidden PLMN list” and enter the state ‘EMMDEREGISTERED.PLMN-SEARCH’ and if the UE is configured to use timer T3245 (see 3GPP TS 24.368 or 3GPP TS 31.102) then the UE shall start timer T3245 and proceed as described in clause 5.3.7a. The UE shall perform a PLMN selection according to 3GPP TS 23.122. If the message has been successfully integrity checked by the NAS and the UE maintains a PLMN-specific attempt counter for that PLMN, then the UE shall set this counter to the UE implementation-specific maximum value.

For the EMM cause value #11, if the UE is operating in single-registration mode, the UE shall in addition handle the 5G mobility management (5GMM) parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value. For the EMM cause value #35, if the UE is operating in single-registration mode, the UE shall in addition set the 5GMM state to 5GMMDEREGISTERED, 5GS update status to 5U3 ROAMING NOT ALLOWED, and shall delete any 5G-GUTI, last visited registered TAI, TAI list and ngKSI. Additionally, the UE shall reset the registration attempt counter.

The UE shall set the EPS update status to EU3 ROAMING NOT ALLOWED (and shall store it according to clause 5.1.3.3) and shall delete any GUTI, last visited registered TAI, TAI list and eKSI. Additionally, the UE shall reset the attach attempt counter. In S1 mode, the UE shall store the current TAI in the list of “forbidden tracking areas for regional provision of service” and enter the state EMM-DEREGISTERED.LIMITED-SERVICE. If the ATTACH REJECT message is not integrity protected, the UE shall memorize the current TAI was stored in the list of “forbidden tracking areas for regional provision of service” for non-integrity protected NAS reject message. If the UE is operating in single-registration mode, the UE shall in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

In an embodiment, the UE shall set the EPS update status to EU3 ROAMING NOT ALLOWED (and shall store it according to clause 5.1.3.3) and shall delete any GUTI, last visited registered TAI, TAI list and eKSI. The UE shall delete the list of equivalent PLMNs and reset the attach attempt counter. In S1 mode, the UE shall store the current TAI in the list of “forbidden tracking areas for roaming”. If the ATTACH REJECT message is not integrity protected, the UE shall memorize the current TAI that was stored in the list of “forbidden tracking areas for roaming” for non-integrity protected NAS reject message. Additionally, the UE shall enter the state EMM-DEREGISTERED.LIMITED-SERVICE or optionally EMMDEREGISTERED.PLMN-SEARCH. If the UE is registered in NI mode and operating in dual-registration mode, the PLMN that the UE chooses to register in is specified in 3GPP TS 24.501 clause 4.8.3. Otherwise, the UE shall perform a PLMN selection according to 3GPP TS 23.122.

If the UE is operating in single-registration mode, the UE shall also handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

In an embodiment, the UE shall set the EPS update status to EU3 ROAMING NOT ALLOWED (and shall store it according to clause 5.1.3.3) and shall delete any GUTI, last visited registered TAI, TAI list and eKSI. Additionally, the UE shall delete the list of equivalent PLMNs and reset the attach attempt counter. In S1 mode, the UE shall store the PLMN identity in the “forbidden PLMNs for GPRS service” list. Additionally, the UE shall the enter state EMM-DEREGISTERED.PLMN-SEARCH and if the UE is configured to use timer T3245 (see 3GPP TS 24.368 [15A] or 3GPP TS 31.102) then the UE shall start timer T3245 and proceed as described in clause 5.3.7a. The UE shall perform a PLMN selection according to 3GPP TS 23.122. If the message has been successfully integrity checked by the NAS and the UE maintains a PLMN-specific PS-attempt counter for that PLMN, then the UE shall set this counter to the UE implementation specific maximum value.

If the UE is operating in single-registration mode, the UE shall in addition set the 5GMM state to 5GMMDEREGISTERED, 5GS update status to 5U3 ROAMING NOT ALLOWED, and shall delete any 5G-GUTI, last visited registered TAI, TAI list and ngKSI. Additionally, the UE shall reset the registration attempt counter.

In another embodiment, the UE shall set the EPS update status to EU3 ROAMING NOT ALLOWED (and shall store it according to clause 5.1.3.3) and shall delete any GUTI, last visited registered TAI, TAI list and eKSI. Additionally, the UE shall reset the attach attempt counter. The UE shall store the current TAI in the list of “forbidden tracking areas for roaming”. If the ATTACH REJECT message is not integrity protected, the UE shall memorize the current TAI was stored in the list of “forbidden tracking areas for roaming” for non-integrity protected NAS reject message. Additionally, the UE shall enter the state EMM-DEREGISTERED.LIMITED-SERVICE and: —if the UE is in WB-S1 mode and the Extended EMM cause IE with value “E-UTRAN not allowed” is included in the ATTACH REJECT message, the UE supports “E-UTRA Disabling for EMM cause #15”, and the “E-UTRA Disabling Allowed for EMM cause #15” parameter as specified in 3GPP TS 24.368 or 3GPP TS 31.102 is present and set to enabled; then the UE shall disable the E-UTRA capability as specified in clause 4.5 and search for a suitable cell in GSM EDGE Radio Access Network (GERAN), UMTS Terrestrial Radio Access Network (UTRAN) or Next Generation Radio Access Network (NG-RAN) radio access technology; if the UE is in NB-S1 mode and the Extended EMM cause IE with value “NB-IoT not allowed” is included in the ATTACH REJECT message, then the UE may disable the NB-IoT capability as specified in clause 4.9 and search for a suitable cell in E-UTRAN radio access technology; otherwise, the UE shall search for a suitable cell in another tracking area or in another location area according to 3GPP TS 36.304.

If the UE is operating in single-registration mode, the UE shall in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

If the T3346 value IE is present in the NAS message and the value indicates that this timer is neither zero nor deactivated, the UE shall proceed as described below; otherwise, it shall be considered as an abnormal case and the behaviour of the UE for this case is specified in clause 5.5.1.2.6. The UE shall abort the attach procedure, reset the attach attempt counter, set the EPS update status to EU2 NOT UPDATED and enter state EMM-DEREGISTERED.ATTEMPTING-TO-ATTACH. The UE shall stop timer T3346 if it is running. If the ATTACH REJECT message is integrity protected, the UE shall start timer T3346 with the value provided in the T3346 value IE. If the ATTACH REJECT message is not integrity protected, the UE shall start timer T3346 with a random value from the default range specified in 3GPP TS 24.008. The UE stays in the current serving cell and applies the normal cell reselection process. The attach procedure is started if still needed when timer T3346 expires or is stopped.

If the UE is operating in single-registration mode, the UE shall also handle the 5GMM parameters 5GMM state, 5GS update status and registration attempt counter as specified in 3GPP TS 24.501 for the case when ETSI 3GPP TS 24.301 version 18.8.0 Release 18 147 ETSI TS 124 301 V18.8.0 (2024-10) the initial registration procedure performed over 3GPP access is rejected with the 5GMM cause with the same value.

In an embodiment, the UE shall set the EPS update status to EU3 ROAMING NOT ALLOWED (and shall store it according to clause 5.1.3.3) and shall delete any GUTI, last visited registered TAI, TAI list and eKSI. Additionally, the UE shall reset the attach attempt counter. The UE shall enable NI mode capability for 3GPP access if it was disabled and disable the E-UTRA capability (see clause 4.5) and enter state EMM-DEREGISTERED.NO-CELL-AVAILABLE. If the UE is operating in single-registration mode, the UE shall in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

The UE behaviour described above may apply to UE registered on a PLMN or SNPN.

### DETAILED DESCRIPTION

In the document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

FIG. 1A illustrates an environment 100 for managing a User Equipment (UE) 105 roaming in disaster conditions according to an embodiment of the disclosure.

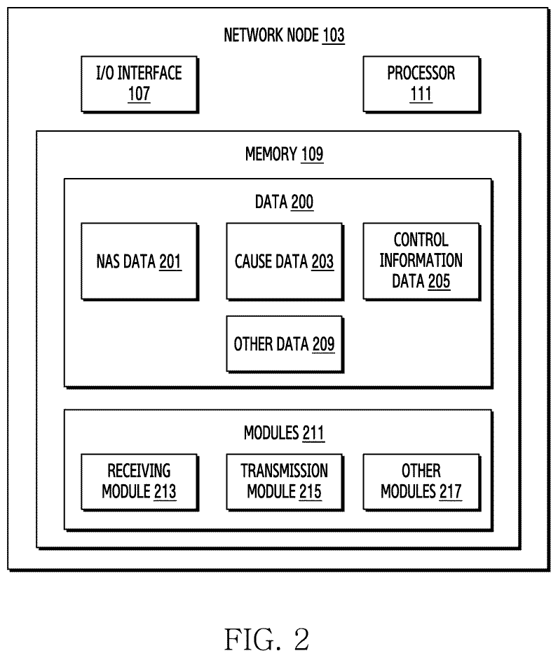

Referring to FIG. 2, FIG. 1A presents a network environment 100 comprising a home network 101 and a Visited Public Land Mobile Network (VPLMN) 102, interlinked to support effective communication services during disaster scenarios.

The home network 101 may be responsible for initiating communication, where the UE 105 ordinarily connects to access various services. Further, the environment 100 includes a Visited Public Land Mobile Network (VPLMN) 102 which a user associated with the UE 105 may access, especially when they are roaming away from the home network. In the VPLMN 102, the UE 105 may be connected to a network node 103 associated with a primary PLMN for availing roaming services. In an embodiment, the primary PLMN may be 5GS.

During an occurrence of a disaster condition in the primary PLMN, the UE 105 may switch to a network node 104 associated with a secondary PLMN which may provide disaster roaming services. In an embodiment, the secondary PLMN may be associated with EPS.

FIG. 1B illustrates a block diagram of a network node for managing the registration of User Equipment (UE) during disaster roaming conditions according to an embodiment of the disclosure.

The network node 103 and 104 comprises an input output (I/O) Interface 107, Memory 109, and a Processor 111.

Referring to FIG. 1A, once the disaster condition is no longer applicable, the network node 103 associated with the primary PLMN may indicate the same to the network node 104 associate with the secondary PLMN. In order to indicate that the primary PLMN is no longer under disaster conditions or that the secondary PLMN does not provide disaster roaming services anymore, the secondary PLMN can use an existing or a new downlink NAS message. The secondary PLMN providing disaster roaming service may use NAS messages to indicate that the disaster condition no longer applies to the UE 105 or that disaster roaming is no longer supported or disaster condition has ended or that the UE has to go back to 5GS. In an embodiment, the secondary PLMN may use an existing Information Element (IE) or a new IE in a downlink NAS message to signal that the disaster condition is no longer applicable or that the secondary PLMN no longer provides disaster roaming services to the UE. The message may include an indication that such information is also provided as part of the message.

In an embodiment, on receiving an indication that the primary PLMN is available and is no longer under disaster condition or that the secondary PLMN no longer offers disaster roaming services, optionally the PLMN(s) (i.e. PLMN-IDs) for which disaster condition has ended are indicated to the UE, the UE may reselect the network node 103 associated with the primary PLMN that was providing service before the disaster condition occurred; i.e., the UE should trigger the PLMN selection procedure or cell selection or cell reselection procedure. Optionally, if the UE is in the registered state, it may continue to remain in the registered state (i.e., EMM REGISTERED state). A detailed description of the various aspects concerning managing user equipment roaming in disaster conditions is elaborated in the upcoming paragraphs in conjunction with FIGS. 2 to 6.

FIG. 2 illustrates a detailed block diagram of a network node according to an embodiment of the disclosure.

Referring to FIG. 2, the network node 104 comprises an I/O Interface 107, a processor 111, and memory 109 interconnected to facilitate effective data handling and management of UE during disaster scenarios.

The I/O Interface 107 is responsible for managing input and output operations between the network node and external devices or systems. This component enables the network node 104 to receive incoming data from the UE 105, such as information regarding changes in connectivity status, and to send signals back to the UE, including notifications about the termination of disaster conditions and directives for re-registration with the primary PLMN. The I/O Interface 107 thus safeguards seamless data flow, vital for effective network management during emergencies.

The memory 109 serves as the storage unit for maintaining both data 200 and instructions necessary for the operational integrity of the system. The data 200 includes NAS data 201, cause data 203, control information data 205, and other data 209. In one embodiment, memory 109 is capable of storing machine executable instructions. By storing this information, the memory 109 enables the processor 111 to efficiently retrieve required data for the execution of tasks, ensuring that the network node can react appropriately to dynamic changes during disaster scenarios.

The processor 111 functions as the core computational unit within the network node 104. It executes instructions and processes data received from the memory and the I/O Interface. In an embodiment, the processors 111 is embodied as executors of software instructions. As such, the processors 111 is capable of executing the instructions stored in the memory 109 to perform one or more operations described herein. The processor 111 is crucial for determining the flow of operations based on the conditions detected, such as transitioning the UE from a secondary to a primary PLMN upon confirmation that a disaster condition has ended.

In an embodiment, the various components of the network node 104 may be implemented using hardware, software, firmware, or any combinations thereof. Further, the various components of the network node 104 may be operably coupled with each other. Specifically, various components of the network node 103 and 104 may be capable of communicating with each other using communication channel media (such as buses, interconnects, etc.).

Data and control signals flow between these components in a systematic manner. For instance, the I/O Interface 107 receives inputs from the UE 105, which then alerts the processor 111 to execute specific routines based on the disaster condition status relayed through the memory 109. The processor 111 processes these inputs and, as necessary, formulates NAS messages to be sent back via the I/O Interface to influence the UE's registration status with the primary PLMN.

The implementation approach for these components typically involves a combination of hardware and software elements. The network node 103, I/O Interface, and processor may be realized in dedicated hardware configurations, such as processors, integrated circuits, or other computing hardware. Alternatively, these functionalities can also be encapsulated using software running on general-purpose hardware. In some embodiments, the architecture may accommodate optional components, such as additional processing units for load balancing or specialized communication modules for enhanced data transmission. These optional features can adapt the node's performance under different operational scenarios, further enhancing the network's reliability and efficacy in disaster roaming situations.

Data flows systematically between these components. In an example, the I/O Interface receives input about the current state of the UE and any notifications regarding the disaster condition from the external environment. This data is relayed to the processor, which consults the memory to assess the appropriate course of action. Following the processing of this information, commands and NAS messages are generated and then sent back to the I/O Interface, which in turn communicates the necessary updates to the UE.

In an embodiment, the processor may be embodied as multi-core processors, single core processors, or a combination of one or more multi-core processors and one or more single core processors. For example, the processors may be embodied as one or more of various processing devices, such as a coprocessor, a microprocessor, a controller, a Digital Signal Processor (DSP), a processing circuitry with or without an accompanying DSP, or various other processing devices including, a Microcontroller Unit (MCU), a hardware accelerator, a special-purpose computer chip, or the like.

In another embodiment, the processor may include one or a plurality of processors. At this time, one or a plurality of processors may be a general-purpose processor, such as a Central Processing Unit (CPU), an Application Processor (AP), or the like, a graphics-only processing unit such as a Graphics Processing Unit (GPU), a Visual Processing Unit (VPU), and/or an artificial intelligence (AI)-dedicated processor such as a neural processing unit (NPU).

The processor 111 may include modules 211, but not limited to, a receiving module 213, a transmission module 215 and other modules 217.

The receiving module 213 may be configured to receive an indication about a termination of a disaster condition, from the network node 103 associated with the primary PLMN.

The transmitting module 215 may be configured to manage outbound messages and data flows, facilitating the seamless return of processed information to the UE or other relevant network components. The transmitting module 215 may be configured to transmit a NAS message comprising Radio Access Technology (RAT) utilization control information and predefined reject cause to the UE 105 for indicating the UE to re-attach to the primary PLMN over 5GS. The details of the NAS message may be stored in the memory 109 under NAS data 201. The RAT utilization control information is configured to prevent the UE from re-attaching to the secondary PLMN over EPS. In an embodiment, the predefined reject cause is selected from one of: a dedicated cause indicating that the detach request is due to the termination of the disaster condition and a set of causes comprising at least, cause #11 (PLMN not allowed), cause #12 (Tracking area not allowed), cause #13 (Roaming not allowed in this tracking area), cause #14 (EPS services not allowed in this PLMN), cause #15 (No suitable cells in tracking area), cause #31 (Redirection to 5GCN required), cause #35 (Requested service option not authorized in this PLMN). In an embodiment, the NAS message comprises one of, Globally Unique Temporary Identifier (GUTI) relocation command and network-initiated deregistration, when the UE is in connected mode with EMM cause #11 or #13 or #15 or #31. Alternatively, the network node 104 may send attach reject, tracking area update reject or service reject, when the UE is in idle mode with EMM cause #11 or #13 or #15 or #31. The details of the pre-defined causes may be stored in the memory 109 under cause data 203.

The other modules 217 depicted signify additional functional units that may perform various auxiliary tasks, tailoring the system to accommodate unique requirements during dynamic operational scenarios such as disasters. These modules 217 enhance the network node's capabilities, ensuring comprehensive and adaptable management of RAT utilization, particularly in critical situations that necessitate precise control and quick transitions to maintain service continuity and user access.

The interconnected nature of these components ensures that data, control signals, and operational commands flow smoothly between them, enabling effective disaster management and support for user equipment roaming during varying conditions.

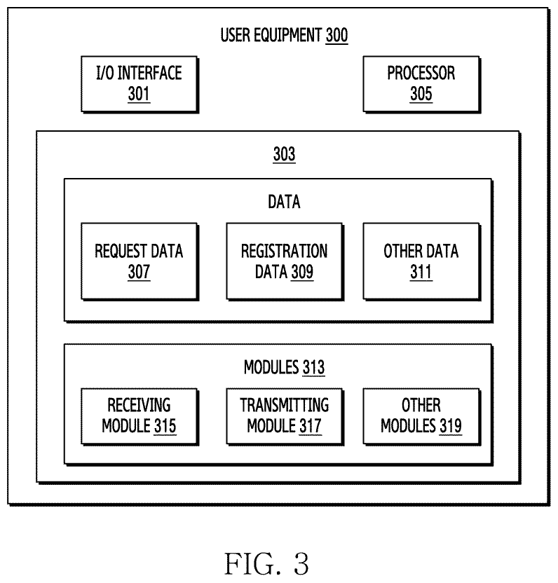

FIG. 3 illustrates a detailed block diagram of a user equipment according to an embodiment of the disclosure.

The diagram presents a structured overview of the components that constitute the user equipment (UE) 300, designed to facilitate effective communication within a network, particularly during disaster roaming conditions. The UE 300 is analogous to the UE 105 defined in FIG. 1A.

Referring to FIG. 3, the UE 105 comprises an I/O Interface 301, a processor 305, and memory 303 interconnected to facilitate effective data handling and management of UE during disaster scenarios.

The I/O Interface 301 is responsible for managing input and output operations between the UE and external devices or systems. This component enables the UE to receive incoming data from the network node 104, such as NAS message, including notifications about the termination of disaster conditions and directives for re-registration with the primary PLMN.

The memory 303 serves as the storage unit for maintaining both data and instructions necessary for the operational integrity of the system. In one embodiment, memory 303 is capable of storing machine executable instructions. By storing this information, the memory 303 enables the processor 305 to efficiently retrieve required data for the execution of tasks, ensuring that the UE can react appropriately to dynamic changes during disaster scenarios. The memory 303 may store data such as, request data 307, registration data 309 and other data 311 that facilitate a range of operational tasks.

The processor 305 serves as the core computational unit, executing instructions and processing data. It is responsible for coordinating operations involving data management and user interactions, which are essential for effective network communication. The processor 305 may execute complex algorithms required to manage the user equipment's response to changing network conditions, particularly in emergency scenarios. In another embodiment, the processor 305 functions as the core computational unit within the network node. It executes instructions and processes data received from the memory and the I/O Interface. In an embodiment, the processor 307 is embodied as executors of software instructions. As such, the processor 305 is capable of executing the instructions stored in the memory 303 to perform one or more operations described herein. The processor 305 is crucial for determining the flow of operations based on the conditions detected.

The various components of the UE 300 may be implemented using hardware, software, firmware, or any combinations thereof. Further, the various components of the UE 300 may be operably coupled with each other. Specifically, various components of the UE 300 may be capable of communicating with each other using communication channel media (such as buses, interconnects, etc.).

Data and control signals flow between these components in a systematic manner. For instance, the I/O interface 301 receives inputs from the network node 104, which then alerts the processor 305 to execute specific routines based on the disaster condition status relayed through the memory 303. The processor 305 processes these inputs and, as necessary, formulates re-registration request to be sent back via the I/O Interface 301 to the primary PLMN.

The implementation approach for these components typically involves a combination of hardware and software elements. The UE 300 and associated components may be realized in dedicated hardware configurations, such as processors, integrated circuits, or other computing hardware. Alternatively, these functionalities can also be encapsulated using software running on general-purpose hardware. In some embodiments, the architecture may accommodate optional components, such as additional processing units for load balancing or specialized communication modules for enhanced data transmission.

In an embodiment, the processor 305 may be embodied as multi-core processors, single core processors, or a combination of one or more multi-core processors and one or more single core processors. For example, the processors may be embodied as one or more of various processing devices, such as a coprocessor, a microprocessor, a controller, a Digital Signal Processor (DSP), a processing circuitry with or without an accompanying DSP, or various other processing devices including, a Microcontroller Unit (MCU), a hardware accelerator, a special-purpose computer chip, or the like.

In another embodiment, the processor 305 may include one or a plurality of processors. At this time, one or a plurality of processors may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a neural processing unit (NPU).

The processor 305 may include modules 313, including, a receiving module 315, a transmission module 317 and other modules 319.

In an embodiment, the receiving module 315 may be configured to specifically manages incoming data reception from various sources, processing the signals that inform the user equipment of network conditions or user inputs. The receiving module 315 may, for example, receive from the network node 104 associated with the secondary Public Land Mobile Network (PLMN), a NAS message comprising Radio Access Technology (RAT) utilization control information and predefined reject cause indicating to re-attach to the primary Public Land Mobile Network (PLMN). The NAS message indicates a termination of a disaster condition. The NAS message may be stored as request data 307 in the memory 303. The RAT utilization control information is configured to prevent the UE from re-attaching to the secondary PLMN. Herein, the predefined reject cause is selected from one of: a dedicated cause indicating that the NAS message is due to the termination of the disaster condition and a set of causes comprising at least, cause #11 (PLMN not allowed), cause #12 (Tracking area not allowed), cause #13 (Roaming not allowed in this tracking area), cause #14 (EPS services not allowed in this PLMN), cause #15 (No suitable cells in tracking area), cause #22 (Congestion), cause #31 (Redirection to 5G Core Network (5GCN) required), cause #35 (Requested service option not authorized in this PLMN).

In an embodiment, the transmitting module 317 may be responsible for sending data and signals from the UE 300. The transmitting module 317 may transmit a re-registration request to the primary PLMN. The details relating to the re-registration request is stored in the memory 303 as re-registration data 309. In an embodiment, the reregistration request comprises reapplying an existing RAT utilization control policy being used by the UE 300 before the occurrence of the disaster condition.

The other modules 319 may represent additional units that can perform specialized functions to enhance the user equipment's capabilities. These modules 319 can be tailored to specific needs, thus augmenting the overall performance and adaptability of the user equipment in varying operational conditions. In an embodiment, the other modules 319 may include a timer module which may, prior to receiving the NAS message, may pause a timer when the UE 300 switches from the primary PLMN to the secondary PLMN to obtain roaming services during the disaster condition. Further, on receiving the NAS message, the timer module may reinitiate the timer with a remaining duration of the timer on detecting the termination of the disaster condition.

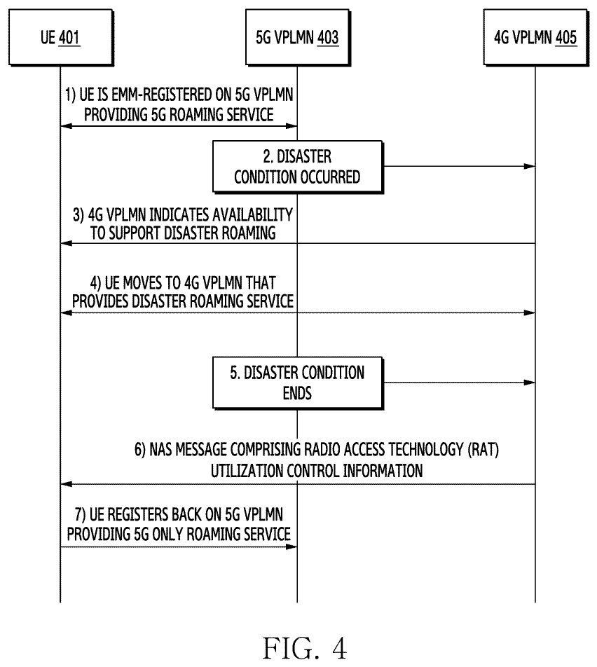

FIG. 4 illustrates a sequence diagram for managing user equipment (UE) registration during disaster roaming conditions according to an embodiment of the disclosure.

The flowchart is organized into a sequence of steps detailing the process for transitioning a UE from a 5G VPLMN to a 4G VPLMN during a disaster condition and subsequently returning to the 5G VPLMN once the disaster condition has ended.

Referring to FIG. 4, at step 1, a UE 401 may be EMM-registered on a 5G VPLMN 403 (primary PLMN). The 5G VPLMN 403 may be providing 5G only roaming service to the UE 401. Once a disaster condition occurs, at step 2, a 4G VPLMN 405 (secondary PLMN) may receive an indication of the occurrence of the disaster.

At step 3, the 4G VPLMN 405 may indicate to the UE 401 an availability to support disaster roaming. Thereafter at step 4, the UE 401 may move to the 4G VPLMN 405 whereby disaster roaming service is provided to the UE 401. Once the disaster condition ends and the disaster condition is no longer applicable, at step 5, the 4G VPLMN 405 is notified of the ending of the disaster condition. The 5G VPLMN 403 may indicate the same to the 4G VPLMN 405 by means that are outside of 3GPP. The 4G VPLMN 405 may indicate the same to the UE via a NAS message comprising Radio Access Technology (RAT) utilization control information and predefined reject cause indicating the UE to re-attach to 5G VPLMN 403.

On receipt of an indication that the 5G VPLMN 403 is no longer under disaster condition, the 4G VPLMN 405 may begin to de-register the UE 401 that are currently being served by EPS. At step 6, the 4G VPLMN 405 sends a NAS message to the UE 401. At step 7, the UE 401 may send a re-attach request to the 5G VPLMN 403. This leads to the UE register back on 5G VPLMN 403 whereby the 5G VPLMN 403 provides 5G only roaming service to the UE 401.

If the UE 401 is not allowed service on 4G VPLMN 405 due to 5G only roaming agreement and the 4G VPLMN is forbidden for the UE e.g. disaster roaming service has ended/disaster condition has ended, the network may de-register/detach the UE with one of the following causes: #11 (PLMN not allowed); #12 (Tracking area not allowed); #13 (Roaming not allowed in this tracking area); #14 (EPS services not allowed in this PLMN); #15 (No suitable cells in tracking area); #31 (Redirection to 5GCN required); #35 (Requested service option not authorized in this PLMN). Alternatively, the network may use a new reject cause/dedicated cause to indicate that the NAS message is a result of the disaster condition being no longer applicable. If a RAT utilization control policy was in force for the 5G VPLMN 403 before the UE 401 moved to 4G VPLMN 405 to obtain disaster roaming services, the UE 401 may re-apply the existing RAT utilization control policy on detecting that the disaster condition is no longer applicable. In an embodiment, if timer, such as T3247 was paused when the UE 401 moved to 4G VPLMN 405 to obtain disaster roaming services, the timer may be re-started with the remaining duration on detecting that the disaster condition is no longer applicable. If the UE 401 received RAT utilization control during registration for disaster roaming or when it was registered for disaster roaming services, the UE 401 may remember the same and delete the RAT utilization control information when disaster roaming condition is no longer applicable.

On receiving the NAS message from a PLMN that was providing disaster roaming services:

In another embodiment, the UE 401 may set the EPS update status to EU3 ROAMING NOT ALLOWED (and may store it according to clause 5.1.3.3) and may delete any GUTI, last visited registered Tracking area ID (TAI), TAI list and eKSI. Additionally, the UE 401 may delete the list of equivalent PLMNs and reset the attach attempt counter. In S1 mode, the UE 401 may store the PLMN identity in the “forbidden PLMN list” and enter state EMMDEREGISTERED.PLMN-SEARCH and if the UE 401 is configured to use timer T3245 (see 3GPP TS 24.368 or 3GPP TS 31.102 [17]) then the UE 401 may start timer T3245 and proceed as described in clause 5.3.7a. The UE 401 may perform a PLMN selection according to 3GPP TS 23.122 [6]. If the message has been successfully integrity checked by the NAS and the UE maintains a PLMN-specific attempt counter for that PLMN, then the UE 401 may set this counter to the UE 401 implementation-specific maximum value.

For the EMM cause value #11, if the UE 401 is operating in single-registration mode, the UE may in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value. For the EMM cause value #35, if the UE is operating in single-registration mode, the UE may in addition set the 5GMM state to 5GMMDEREGISTERED, 5GS update status to 5U3 ROAMING NOT ALLOWED, and may delete any 5G-GUTI, last visited registered TAI, TAI list and ngKSI. Additionally, the UE may reset the registration attempt counter.

In yet another embodiment, the UE 401 may set the EPS update status to EU3 ROAMING NOT ALLOWED (and may store it according to clause 5.1.3.3) and may delete any GUTI, last visited registered TAI, TAI list and eKSI. Additionally, the UE 401 may reset the attach attempt counter. In S1 mode, the UE 401 may store the current TAI in the list of “forbidden tracking areas for regional provision of service” and enter the state EMM-DEREGISTERED.LIMITED-SERVICE. If the ATTACH REJECT message is not integrity protected, the UE may memorize the current TAI was stored in the list of “forbidden tracking areas for regional provision of service” for non-integrity protected NAS reject message. If the UE is operating in single-registration mode, the UE may in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

In still another embodiment, the UE may set the EPS update status to EU3 ROAMING NOT ALLOWED (and may store it according to clause 5.1.3.3) and may delete any GUTI, last visited registered TAI, TAI list and eKSI. The UE may delete the list of equivalent PLMNs and reset the attach attempt counter. In S1 mode, the UE may store the current TAI in the list of “forbidden tracking areas for roaming”. If the ATTACH REJECT message is not integrity protected, the UE may memorize the current TAI was stored in the list of “forbidden tracking areas for roaming” for non-integrity protected NAS reject message. Additionally, the UE may enter the state EMM-DEREGISTERED.LIMITED-SERVICE or optionally EMMDEREGISTERED.PLMN-SEARCH. If the UE is registered in NI mode and operating in dual-registration mode, the PLMN that the UE chooses to register in is specified in 3GPP TS 24.501 clause 4.8.3. Otherwise, the UE may perform a PLMN selection according to 3GPP TS 23.122 [6].

If the UE is operating in single-registration mode, the UE may in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

In another embodiment, the UE may set the EPS update status to EU3 ROAMING NOT ALLOWED (and may store it according to clause 5.1.3.3) and may delete any GUTI, last visited registered TAI, TAI list and eKSI. Additionally, the UE may delete the list of equivalent PLMNs and reset the attach attempt counter. In S1 mode, the UE may store the PLMN identity in the “forbidden PLMNs for GPRS service” list. Additionally, the UE may enter state EMM-DEREGISTERED.PLMN-SEARCH and if the UE is configured to use timer T3245 (see 3GPP TS 24.368 [15A] or 3GPP TS 31.102 [17]) then the UE may start timer T3245 and proceed as described in clause 5.3.7a. The UE may perform a PLMN selection according to 3GPP TS 23.122 [6]. If the message has been successfully integrity checked by the NAS and the UE maintains a PLMN-specific PS-attempt counter for that PLMN, then the UE may set this counter to the UE implementation specific maximum value.

If the UE is operating in single-registration mode, the UE may in addition set the 5GMM state to 5GMMDEREGISTERED, 5GS update status to 5U3 ROAMING NOT ALLOWED, and may delete any 5G-GUTI, last visited registered TAI, TAI list and ngKSI. Additionally, the UE may reset the registration attempt counter.

In another embodiment, the UE may set the EPS update status to EU3 ROAMING NOT ALLOWED (and may store it according to clause 5.1.3.3) and may delete any GUTI, last visited registered TAI, TAI list and eKSI. Additionally, the UE may reset the attach attempt counter. The UE may store the current TAI in the list of “forbidden tracking areas for roaming”. If the ATTACH REJECT message is not integrity protected, the UE may memorize the current TAI stored in the list of “forbidden tracking areas for roaming” for non-integrity protected NAS reject message. Additionally, the UE may enter the state EMM-DEREGISTERED.LIMITED-SERVICE. Additionally, if the UE is in WB-S1 mode and the Extended EMM cause IE with value “E-UTRAN not allowed” is included in the ATTACH REJECT message, the UE supports “E-UTRA Disabling for EMM cause #15”, and the “E-UTRA Disabling Allowed for EMM cause #15” parameter as specified in 3GPP TS 24.368 [15A] or 3GPP TS 31.102 is present and set to enabled; then the UE may disable the E-UTRA capability as specified in clause 4.5 and search for a suitable cell in GERAN, UTRAN or NG-RAN radio access technology. Further, if the UE is in NB-S1 mode and the Extended EMM cause IE with value “NB-IoT not allowed” is included in the ATTACH REJECT message, then the UE may disable the NB-IoT capability as specified in clause 4.9 and search for a suitable cell in E-UTRAN radio access technology. Otherwise, the UE may search for a suitable cell in another tracking area or in another location area according to 3GPP TS 36.304 [21].

If the UE is operating in single-registration mode, the UE may, in addition, handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

In another embodiment, if the T3346 value IE is present in the ATTACH REJECT message and the value indicates that this timer is neither zero nor deactivated, the UE may proceed as described below; otherwise, it may be considered as an abnormal case and the behaviour of the UE for this case is specified in clause 5.5.1.2.6. The UE may abort the attach procedure, reset the attach attempt counter, set the EPS update status to EU2 NOT UPDATED and enter state EMM-DEREGISTERED.ATTEMPTING-TO-ATTACH. The UE may stop timer T3346 if it is running. If the ATTACH REJECT message is integrity protected, the UE may start timer T3346 with the value provided in the T3346 value IE. If the ATTACH REJECT message is not integrity protected, the UE may start timer T3346 with a random value from the default range specified in 3GPP TS 24.008 [13]. The UE stays in the current serving cell and applies the normal cell reselection process. The attach procedure is started if still needed when timer T3346 expires or is stopped.

If the UE is operating in single-registration mode, the UE may in addition handle the 5GMM parameters 5GMM state, 5GS update status and registration attempt counter as specified in 3GPP TS 24.501 for the case when ETSI 3GPP TS 24.301 version 18.8.0 Release 18 147 ETSI TS 124 301 V18.8.0 (2024-10) the initial registration procedure performed over 3GPP access is rejected with the 5GMM cause with the same value.

The EMM cause #31 received by a UE that has not indicated support for CIoT optimizations or not indicated support for NI mode is considered as an abnormal case and the behavior of the UE is specified in clause 5.5.1.2.6. The UE may set the EPS update status to EU3 ROAMING NOT ALLOWED (and may store it according to clause 5.1.3.3) and may delete any GUTI, last visited registered TAI, TAI list and eKSI. Additionally, the UE may reset the attach attempt counter. The UE may enable NI mode capability for 3GPP access if it was disabled and disable the E-UTRA capability (see clause 4.5) and enter state EMM-DEREGISTERED.NO-CELL-AVAILABLE. If the UE is operating in single-registration mode, the UE may in addition handle the 5GMM parameters 5GMM state, 5GS update status, 5G-GUTI, last visited registered TAI, TAI list, ngKSI and registration attempt counter as specified in 3GPP TS 24.501 for the case when the initial registration procedure performed over 3GPP access is rejected with the 5GMM cause with the same value.

The UE behavior described above may apply to UE registered on a PLMN or SNPN.

In an example, consider a user in a region served by a 5G VPLMN whose UE is registered on this network while traveling during a natural disaster. Upon the disaster's occurrence, the 4G network detects the emergency and indicates it can offer disaster services, prompting the user's UE to switch. The user successfully transitions to the 4G VPLMN for essential communication services. Once the disaster terminates, the system uses automated NAS messages containing RAT utilization controls, prompting the user's device to re-register and return to the preferred 5G service, thus restoring normal operations. The described steps provide several technical advantages over prior art. By efficiently managing transitions between 5G and 4G networks during crisis scenarios, the method enhances service availability and reliability under adverse conditions. Moreover, this adaptive network management improves the accuracy of user registrations, ensuring an optimal communication path is maintained throughout varying circumstances. This scalability allows the system to cater to a multitude of users, improving the network's resilience and responsiveness to disaster situations.

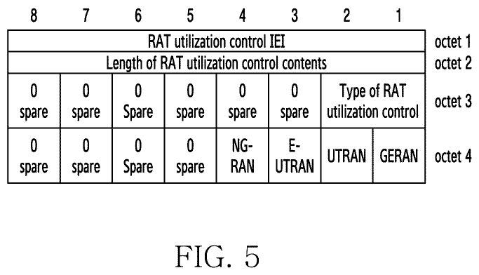

FIG. 5 is a representation of a RAT utilization control information element according to an embodiment of the disclosure.

The purpose of the RAT utilization control information element is for the network to communicate the restricted RAT(s) to the UE. The RAT utilization control information element is coded as shown in FIG. 5.

Referring to FIG. 5, octet 1 stores the RAT utilization control IEI, octet 2 stores the length of RAT utilization control contents, octet 3 stores type of RAT utilization control and octet 4 stores NG-RAN, E-UTRAN and GERAN.

Table 1 describes Type of RAT Utilization Control (octet 3, bit 1 to 2). The RAT utilization control information element is coded as shown in Table 1 below. The type of RAT utilization control and the bits utilized are provided in the table.

TABLE 1
Type of RAT utilization control (octet 3, bit 1 to 2)

Bits

| 2 | 1 | |
|---|---|---|
| 0 | 0 | current PLMN |
| 0 | 1 | Unused, shall be interpreted as |
| | | “current PLMN” if received by the UE |
| 1 | 0 | Unused, shall be interpreted as |
| | | “current PLMN” if received by the UE |
| 1 | 1 | Unused, shall be interpreted as |
| | | “current PLMN” if received by the UE |

GERAN (octet 4, bit 1)

| Bit | |
|---|---|
| 1 | |
| 0 | GERAN is not restricted |
| 1 | GERAN is restricted |

UTRAN (octet 4, bit 2)

| Bit | |
|---|---|
| 2 | |
| 0 | UTRAN is not restricted |
| 1 | UTRAN is restricted |

E-UTRAN (octet 4, bit 3)

| Bit | |
|---|---|
| 3 | |
| 0 | E-UTRAN is not restricted |
| 1 | E-UTRAN is restricted |

NG-RAN (octet 4, bit 4)

| Bit | |
|---|---|
| 4 | |
| 0 | NG-RAN is not restricted |
| 1 | NG-RAN is restricted |

The RAT utilization control is a type 4 information element.

### RAT Restriction Policy Application

Before the policy is exchanged between the UE and network, the UE should have set the RAT utilization control (RATUC) bit to “RAT utilization control supported” in the 5GMM capability IE.

Once the UE receives the RAT utilization control information, the existing policy, if any, may be replaced with the received policy.

The RAT utilization control information may not apply to a UE in Emergency mode or when a Disaster condition is detected or when the UE is camped for Disaster roaming or when the UE is in Manual mode.

If the UE received a reject cause earlier (say #27) which restricted the UE on a particular RAT and the new policy does not restrict that RAT for the UE, the UE is allowed to access the RAT.

If the UE has restricted a RAT due to voice not being available on that RAT, then, the RAT restriction policy does not take effect for that RAT.

If all of the supported RAT of the UE are restricted for a PLMN, it should be treated as a FPLMN.

The term area/location/geographical area are used in this embodiment may refer to any of cell/cell ID, TAC/TAI, PLMN, MCC/MNC, Latitude/longitude, CAG cell or any geographical location/coordinate.

If the network did not include a timer value for the RAT restriction, then the UE may choose a time duration ‘T’ for which the policy may be in effect. It is up to UE implementation on what duration to choose for ‘T’.

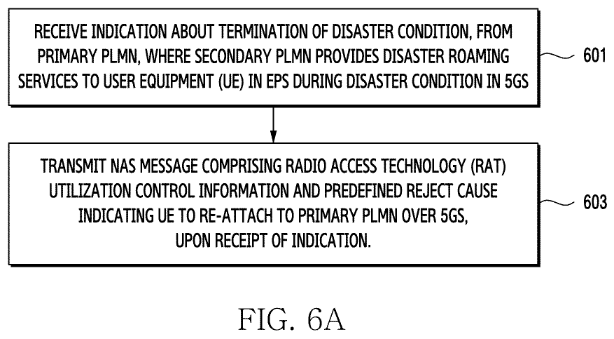

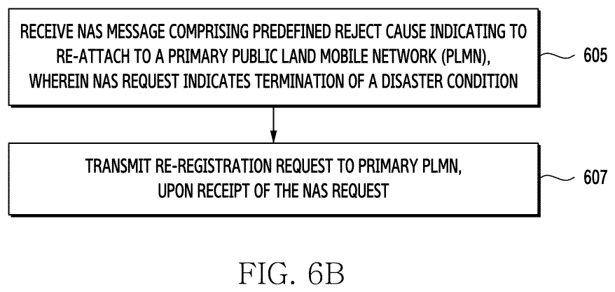

FIG. 6A illustrates a flowchart for managing the registration of User Equipment (UE) during disaster roaming conditions according to an embodiment of the disclosure.

The flowchart sequentially outlines the key steps involved in transitioning a UE from a secondary Public Land Mobile Network (PLMN) to a primary PLMN following the termination of a disaster condition. The method is implemented by the network node 104 associated with the secondary PLMN. The method may comprise one or more steps. The method may be described in the general context of computer executable instructions. Generally, computer executable instructions can include routines, programs, objects, components, data structures, procedures, modules, and functions, which perform particular functions or implement particular abstract data types.

Further, the order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

Referring to FIG. 6A, at operation 601, the process begins with the receipt of an indication about the termination of a disaster condition from the primary PLMN. This step informs the secondary PLMN that the circumstances warranting the disaster roaming services for the UE are no longer present. The secondary PLMN, during the disaster, had been providing essential services to the UE, and such indications are necessary for effective network management and resource optimization.

In operation 603, upon receiving this indication, the secondary PLMN transmits the NAS message comprising Radio Access Technology (RAT) utilization control information and predefined reject cause indicating the UE to re-attach to the primary PLMN over 5GS.

For instance, consider a user whose device is registered on a 5G PLMN while traveling. During a natural disaster, the device is switched to a 4G network for emergency services. Once the disaster concludes, the 4G network sends a notification to the UE, indicating the end of the disaster status, upon which the UE is directed to revert back to the 5G PLMN through a compiled NAS message. This operation not only simplifies the return process but also reinforces the directive nature of the network in managing device connections optimally. The technical advantages of this method include improved efficiency in managing user network transitions in emergency scenarios, thereby bolstering service continuity and reliability. Compared to existing methods, this flowchart embodies a streamlined protocol for swiftly re-routing UE back to preferred networks, which is beneficial in maintaining uninterrupted telecommunications during times of crisis. This enhances user experience by minimizing downtime but also optimize network resource utilization.

FIG. 6B illustrates a flowchart for managing registration of User Equipment (UE) during the transition from a disaster roaming condition to normal operations, according to an embodiment of the disclosure.

The method is implemented by the UE 105, 300. The method may comprise one or more steps. The method may be described in the general context of computer executable instructions. Generally, computer executable instructions can include routines, programs, objects, components, data structures, procedures, modules, and functions, which perform particular functions or implement particular abstract data types.

Further, the order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

Referring to FIG. 6B, at operation 605, the process begins with the receipt of a NAS message comprising Radio Access Technology (RAT) utilization control information and a predefined reject cause indicating to re-attach to a primary Public Land Mobile Network (PLMN), This NAS message specifically indicates that a disaster condition has been terminated. The context here involves a situation where the UE has been acquiring connectivity through a secondary PLMN under disaster conditions, which necessitated the service.

In this example scenario, consider a user whose device was previously registered on a 5G VPLMN and switched to a 4G VPLMN to access necessary services during a disaster. Upon the disaster condition termination, the user's device receives the NAS message indicating to revert back to the preferred 5G network.

Moving to operation 607, the UE may transmit again a registration request to the primary PLMN upon receipt of the NAS request. This action represents the operational response from the UE based on the directive communicated through the NAS message in operation 505. Particularly, the request signals the UE to detach from the 4G network and attempt to re-establish a connection with the primary 5G PLMN, thereby transitioning back to regular service operations once the disaster condition has subsided.

The technical advantage of this method compared to prior art lies in its efficiency in managing transitions between network services during emergency situations. By ensuring that the process of moving back to a primary PLMN is automated and guided by specific NAS messages, the method reduces the likelihood of user disruption and facilitates prompt service restoration. This improves overall service reliability and accuracy in user registration, thereby enhancing user experience and optimizing network resource utilization compared to existing methods. The systematic nature of these steps demonstrates a scalable solution to managing user connectivity in varying operational contexts, particularly after disaster scenarios.

The illustrated steps are set out to explain the embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices. The functionality and/or the features of a device may be alternatively embodied by one or more other devices which are not explicitly described as having such functionality/features. Thus, other embodiments of the disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments is intended to be illustrative, but not limiting, of the scope of the disclosure, which is set forth in the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of managing registration of a user equipment (UE) during disaster roaming conditions, the method comprising:
receiving, by a network node associated with a secondary public land mobile network (PLMN), an indication about a termination of a disaster condition, from a primary PLMN, wherein the secondary PLMN provides disaster roaming services to the UE in an evolved packet system (EPS) during the disaster condition in fifth generation system (5GS); and
transmitting, by the network node to the UE, a non-access stratum (NAS) message comprising radio access technology (RAT) utilization control information and a predefined reject cause indicating the UE to re-attach to the primary PLMN over the 5GS, upon receipt of the indication.

2. The method of claim 1, wherein the predefined reject cause is selected from one of:
a dedicated cause indicating that a detach request is due to the termination of the disaster condition; and
a set of causes comprising at least one of cause #11 (PLMN not allowed), cause #12 (tracking area not allowed), cause #13 (roaming not allowed in this tracking area), cause #14 (EPS services not allowed in this PLMN), cause #15 (no suitable cells in tracking area), cause #31 (redirection to fifth generation core network (5GCN) required), or cause #35 (requested service option not authorized in this PLMN).

3. The method of claim 1, wherein the RAT utilization control information is configured to prevent the UE from re-attaching to the secondary PLMN over EPS.

4. The method of claim 1, wherein the NAS message comprises one of, global unique temporary Identifier (GUTI) relocation command and network-initiated deregistration, when the UE is in connected mode.

5. The method of claim 1, wherein the NAS message comprises attach reject, tracking area update reject or service reject, when the UE is in idle mode.

6. A method of restoring service to a user equipment (UE) during a disaster condition, the method comprising:
receiving, by the UE, from a network node associated with a secondary public land mobile network (PLMN), a non-access stratum (NAS) message comprising radio access technology (RAT) utilization control information and a predefined reject cause indicating to re-attach to a primary PLMN, wherein the NAS message indicates a termination of a disaster condition; and
transmitting, by the UE, a re-registration request to the primary PLMN, upon receipt of the NAS message.

7. The method of claim 6, wherein the predefined reject cause is selected from one of:
a dedicated cause indicating that the NAS message is due to the termination of the disaster condition; and
a set of causes comprising at least one of cause #11 (PLMN not allowed), cause #12 (tracking area not allowed), cause #13 (roaming not allowed in this tracking area), cause #14 (EPS services not allowed in this PLMN), cause #15 (no suitable cells in tracking area), cause #22 (congestion), cause #31 (redirection to fifth generation core network (5GCN) required), or cause #35 (requested service option not authorized in this PLMN).

8. The method of claim 6, wherein the RAT utilization control information is configured to prevent the UE from re-attaching to the secondary PLMN.

9. The method of claim 6, wherein the re-registration request comprises reapplying an existing RAT utilization control policy being used by the UE before an occurrence of the disaster condition.

10. The method of claim 6, wherein prior to receiving the NAS message, the method comprising pausing a timer when the UE switches from the primary PLMN to the secondary PLMN to obtain roaming services during the disaster condition.

11. The method of claim 10, further comprising restarting the timer with a remaining duration of the timer on detecting the termination of the disaster condition.

12. A network node for managing registration of a user equipment (UE) during disaster roaming conditions, the network node being associated with a secondary public land mobile network (PLMN), the network node comprising:
memory, comprising one or more storage media, storing instructions; and
at least one processor communicatively coupled to the memory,
wherein the at least one processor is configured to:
receive an indication about a termination of a disaster condition, from a primary PLMN, wherein the secondary PLMN provides disaster roaming services to the UE in an evolved packet system (EPS) during the disaster condition in 5GS, and
transmit a non-access stratum (NAS) message comprising radio access technology (RAT) utilization control information and a predefined reject cause indicating the UE to re-attach to the primary PLMN over fifth generation system (5GS), upon receipt of the indication.

13. The network node of claim 12, wherein the at least one processor is configured to:
select the predefined reject cause from one of:
a dedicated cause indicating that the NAS message is due to the termination of the disaster condition; and
a set of causes comprising at least one of cause #11 (PLMN not allowed), cause #12 (tracking area not allowed), cause #13 (roaming not allowed in this tracking area), cause #14 (EPS services not allowed in this PLMN), cause #15 (no suitable cells in tracking area), cause #31 (redirection to fifth generation core network (5GCN) required), or cause #35 (requested service option not authorized in this PLMN).

14. The network node of claim 12, wherein the RAT utilization control information is configured to prevent the UE from re-attaching to the secondary PLMN.

15. A user equipment (UE) for restoring service during a disaster condition, the UE comprising:
memory, comprising one or more storage media, storing instructions; and
at least one processor communicatively coupled to the memory,
wherein the at least one processor is configured to:
receive from a network node associated with a secondary public land mobile network (PLMN), a non-access stratum (NAS) message comprising radio access technology (RAT) utilization control information and a predefined reject cause indicating to re-attach to a primary PLMN, wherein the NAS message indicates a termination of a disaster condition; and
transmit a re-registration request to the primary PLMN, upon receipt of the NAS message.

16. The UE of claim 15, wherein the predefined reject cause is selected from one of:
a dedicated cause indicating that a detach request is due to the termination of the disaster condition, and
a set of causes comprising at least one of cause #11 (PLMN not allowed), cause #12 (tracking area not allowed), cause #13 (roaming not allowed in this tracking area), cause #14 (EPS services not allowed in this PLMN), cause #15 (no suitable cells in tracking area), cause #31 (redirection to 5GCN required), or cause #35 (requested service option not authorized in this PLMN).

17. The UE of claim 15, wherein RAT utilization control information is configured to prevent the UE from re-attaching to the secondary PLMN.

18. The UE of claim 15, wherein for transmitting the re-registration request, the at least one processor is configured to:
reapply an existing RAT utilization control policy being used by the UE before an occurrence of the disaster condition.

19. The UE of claim 15, wherein prior to receiving a detach request, the at least one processor is configured to:
pause a timer when the UE switches from the primary PLMN to the secondary PLMN to obtain roaming services during the disaster condition.

20. The UE of claim 19, wherein the at least one processor is further configured to:
restart the timer with a remaining duration of the timer on detecting a termination of the disaster condition.
